(19) United States
(12) Patent Application Publication
(10) Pub. No.: US 2004/0021283 A1
(43) Pub. Date: Feb. 5, 2004

(54) Sparking pad attachment for skateboard

(76) Inventor: Robert Serling, Cardiff, CA (US)

Correspondence Address: Royal W. Craig, Law Offices of Royal W. Craig, Suite 153, 10 N. Calvert Street, Baltimore, MD, 21202, US

(21) Appl. No.: 10/621,073

(22) Filed: Jul. 15, 2003

Related U.S. Application Data
(60) Provisional application No. 60/398,503, filed on Jul. 24, 2002.

(51) Int. Cl. B62M 1/00

(52) U.S. Cl. 280/87.042

(57) ABSTRACT

A variety of clip-on and self-adhesive sparking pads for skateboards that generate sparks when the pads come in contact with a hard surface, such as cement, asphalt, or metal. Each sparking pad is adhesively applied to the underside of the skateboard and is made in various shapes and sizes to conform to the different areas of the skateboard and skateboard trucks. The sparking pad that fits the trucks or axles can either be self-adhesive or fashioned to clip over the ends of the axle. A plurality of flint or flint-like contact members are embedded in the plastic pad to provide multiple contact points, thereby creating a shower of sparks on contact.

### CROSS-REFERENCE TO RELATED APPLICATIONS

The present application derives priority from U.S. Provisional Patent Application No. 60/398,503 for “SPARKING PAD ATTACHMENT FOR SKATEBOARD”; Filed: Jul. 24, 2002; Inventor: Robert Serling.

### BACKGROUND OF THE INVENTION

1. Field of the Invention

The present invention relates to a device that attaches to a skateboard, and more particularly, to a two-sided pad with embedded flint that attaches to the various surfaces of a skateboard to generate sparks upon contact with a hard surface.

2. Description of the Background

Skateboarding has become a widely-popular sport particularly with teens and young adults. This is in large part due to the speed, conduciveness to tricks, relatively low cost to participate, and low maintenance. Skateboards can even be used for transportation for short distances. There are various types of skateboards and they have become faster, sleeker and much more ornate and aesthetically pleasing over the years. More recently, skateboarding trick shows and competitions have added another excitement level to the sport.

Due to the popularity, a number of attachable accessories have been introduced to enhance the skateboard “look”. For example, radios, toe clips, kick boards, lighting systems, etc. are commercially available.

Skateboarders typically change their speed or apply braking force by placing the driving foot on the back portion of the board, which causes the board to shift downward and meet the road surface, generating friction. The sudden change in speed can be visibly or audibly enhanced by special effects that generate colorful sights and/or exciting sounds. One such visual effect is spark generation.

There have been a few previous attempts at spark generation from a skateboard. For example, U.S. Pat. No. 4,286,806 to Bergstein shows a spark generating mechanism for use with a skateboard that includes a support bracket that rotatably carries a grindstone wheel between two larger actuating wheels and a spark producing element in resilient contact with the grindstone wheel.

U.S. Pat. No. 4,834,407 to Salvo shows a housing structure comprising a flat base and vertical integral fins, each fin having at least one open ended port for housing the spark emitters. The device is bolted on to the underside of the skateboard.

U.S. Pat. No. 6,059,315 to Selph teaches a spark-creating device for attaching to a skateboard, comprising a flint-bearing pad that slides into a receptacle with curled edges to hold the pad in place.

Unfortunately, these known devices are cumbersome and complicated to manufacture and use and relatively expensive to manufacture. They involve replaceable spark-generating flints that fit within a permanent receptacle mounted on or under the board.

Without compromising the special visual effect, it would be greatly advantageous to provide a spark generating device for use on skateboards that is safe, portable, lightweight, compact, easy to use, easily attachable, and inexpensive to manufacture and store.

### SUMMARY OF THE INVENTION

It is, therefore, an object of the present invention to provide a spark generating device for use on skateboards.

It is another object to provide a skateboard spark generating device that automatically generates sparks upon contact with a hard surface, such as cement, asphalt or metal.

It is another object to provide a skateboard spark generating device that can be easily attached and easily removed.

It is yet another object to provide a skateboard spark generating device that is inexpensive to manufacture.

It is still another object to provide a skateboard spark generator that is safe and easy to use.

It is another object to provide a skateboard spark generating device that incorporates various colors, shapes and designs and may be used for promotional purposes.

It is yet another object to provide a skateboard spark generator that is portable, lightweight and compact.

According to the present invention, the above-described and other objects are accomplished by a spark generating device that can be easily affixed to any surface of a skateboard. The device comprises a plastic pad with an adhesive backing and flint or a flint-like substance embedded in the front side of the pad. The pad creates a shower of sparks when the skateboarder brings the pad in contact with a hard surface, such as cement, asphalt, metal, or the like. The sparking pad can be manufactured in a variety of colors, shapes and designs, including company logos or other branding images for promotional purposes. A second embodiment clips on to the axle of the skateboard with the flint or a flint-like substance embedded in the front side of the pad.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which:

FIG. 1 is a view of the underside of a skateboard 2 with various sizes and shapes of sparking pads 10a-c attached according to the present invention.

FIG. 2 is a side view of a skateboard with sparking pads 10 attached according to the present invention.

FIGS. 3 through 5 are a front view, side view and bottom view, respectively, of an end-mounted sparking pad 10a according to the present invention.

FIGS. 6 through 8 are a front view, side view and bottom view, respectively, of a side-mounted sparking pad 10b according to the present invention.

FIGS. 9 through 12 are a front view, side view, bottom view, and perspective side view, respectively, of a truck-mounted sparking pad 10c according to the present invention.

FIGS. 13-16 are a back, top, front, and side view of a second embodiment of a truck-mounted sparking pad 10d according to the present invention.

FIG. 17 is a composite picture of the four step process of applying and using the sparking pads according to the present invention.

### DETAILED DESCRIPTION OF THE PREFERRED EMBODIMENTS

The self-adhesive sparking pads for attachment to skateboards according to the present invention generally comprise a base pad having self-adhesive strip on one side for attachment to the skateboard, an opposing second side forming a raised and exposed surface facing outwardly, and a plurality of flint or flint-like contact members embedded in and protruding from the second side of the base pad. The sparking pad is safe, lightweight, portable, easy to attach and remove, and inexpensive to manufacture. The skateboarder creates a shower of sparks from the friction generated between the flint contact members of the sparking pad(s) and a hard surface, such as cement, asphalt or metal. This friction commonly occurs when the skateboarder steps down on the tail of the board to stop it or while performing various tricks and stunts.

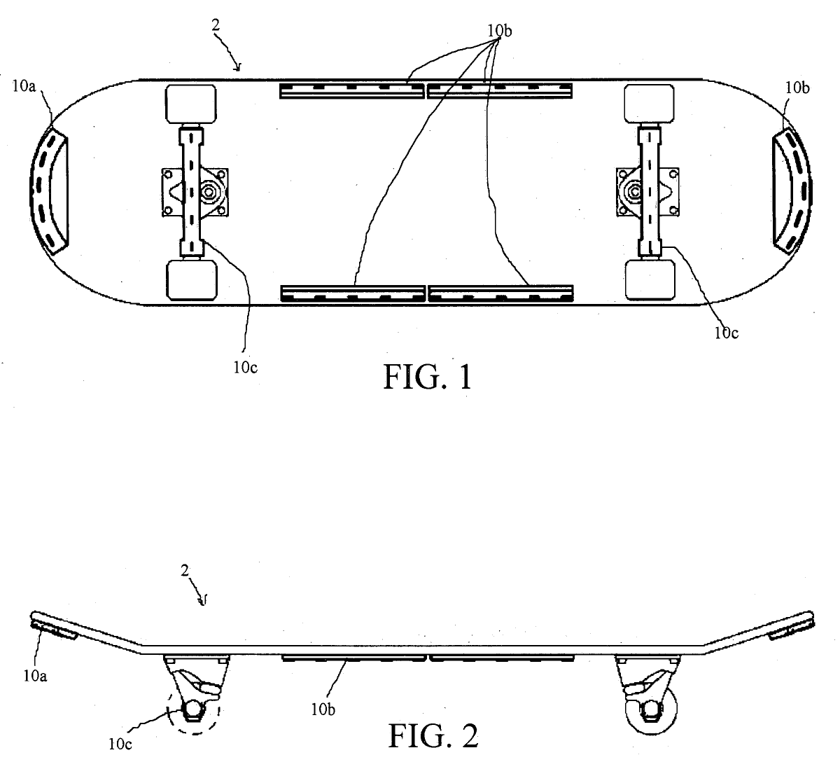

FIG. 1 is a view of the underside of a skateboard 2 with three distinct sizes and shapes of sparking pads 10a-c attached according to the present invention. End-mounted sparking pads 10a are adhesively attached at the front and back (tail) ends of the skateboard. These sparking pads are activated to generate a shower of sparks when the skateboarder presses down on the respective front or tail end of the skateboard causing it to generate friction upon contact with the road surface, thereby igniting the embedded flint to generate the sparks. Side-mounted sparking pads 10b are adhesively attached to the sides of the skateboard and are activated by the skateboarder's trick movements to generate friction between the side of the board and a hard surface. Truck-mounted sparking pads 10c are attached to the skateboard “trucks” or axles that hold the wheels of the board. These sparking pads generate sparks when the skateboarder grinds the axle surface on metal rails or street curbs.

FIG. 2 is a side view of a skateboard as in FIG. 1 with sparking pads 10 attached according to the present invention, inclusive of end-mounted sparking pads 10a, side-mounted sparking pads 10b and truck-mounted sparking pads 10c.

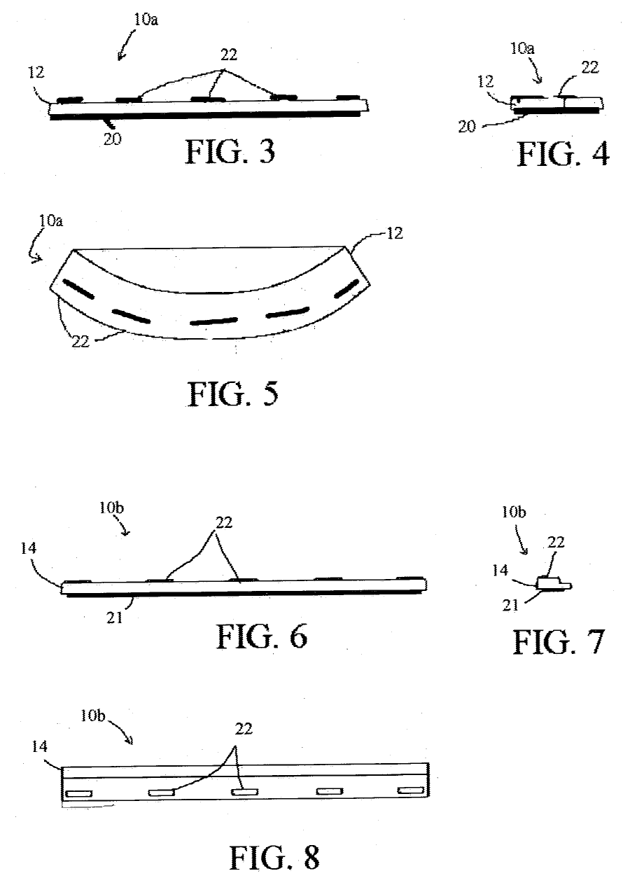

FIGS. 3 through 5 are a front view, side view and bottom view, respectively, of an exemplary end-mounted sparking pad 10a according to the present invention. Each end-mounted sparking pad 10a includes a contoured base pad 12 having self-adhesive strip 20 on one side and a plurality of embedded flint or flint-like contact members 22 protruding from the opposing side of the base pad 12. Referring now to FIG. 3, the adhesive strip 20 of plastic sparking pad 10a is exposed by a peel-away protective film and then adheres to the underside of the skateboard. The sparking pad 10a of FIGS. 3-5 is arcuately or semi-circular in shape and is contoured to fit both front and tail ends of the skateboard. The base pad 12 may be fashioned by molding acrylic polyester, polyester, urethane elastomer, silicone elastomer, or like substances and may be manufactured in a variety of colors, shapes, sizes and designs. Various designs may include corporate logos and other branding images such that the device may be used to promote skateboarding manufacturers, distributers, activities, events, and the like. The shape of the base pad and overall sparking pad may vary depending upon the area of the skateboard or skateboard truck to which it is attached. The plurality of flint contact members 22 may be standard lighter flints which are small cylindrical segments, and they are preferably oriented end-to-end radially with respect to the arc of the base pad 12. The flint contact members 22 are evenly spaced along and are embedded (integrally molded into) in the base pad 12 to provide multiple points of contact and a true shower of sparks. Such flint members are mounted in a forward position on the end-mounted and side-mounted sparking pads and in the middle of the truck-mounted sparking pad to generate optimum sparks from fewer flints.

FIGS. 6 through 8 are a front view, side view and bottom view, respectively, of a side-mounted sparking pad 10b according to the present invention. Each side-mounted sparking pad 10b includes an elongate base pad 14 having self-adhesive strip 21 on one side and a like plurality of embedded flint or flint-like contact members 22 evenly spaced along and protruding from the opposing side of the base pad 14. As before, the adhesive strip 21 of plastic sparking pad 10b is exposed by a peel-away protective film and then adheres to the underside of the skateboard. It is intended that two opposing side-mounted sparking pads 10b be adhered along the opposing sides of the skateboard. The sparking pad 10b of FIGS. 6-8 is specifically long and thin to fit the opposing sides of the skateboard. As before, the plurality of flint contact members 22 are evenly spaced along and are embedded in the base pad 14 to provide multiple points of contact and a true shower of sparks.

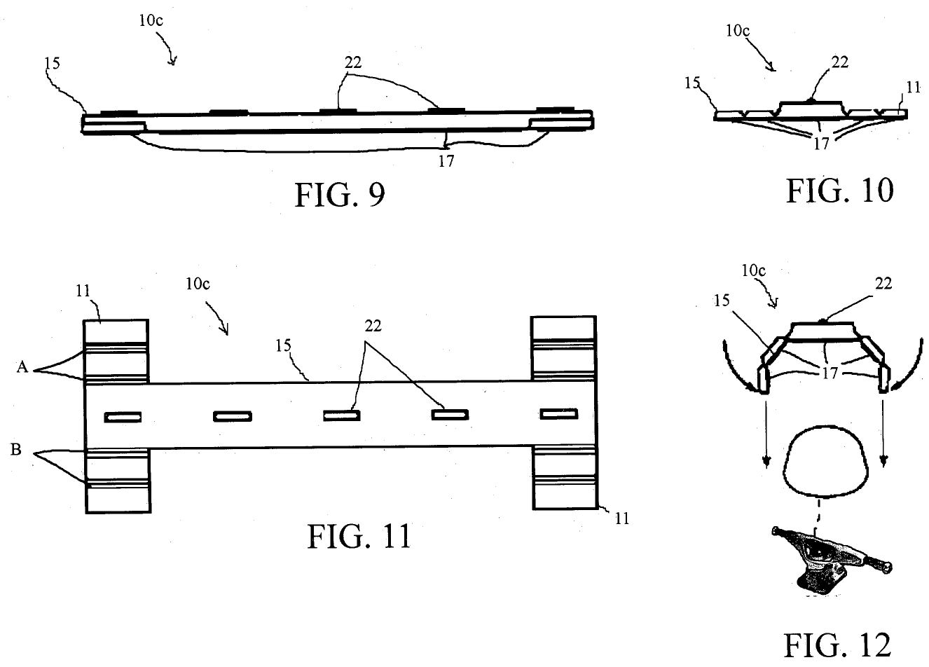

FIGS. 9 through 12 are a front view, side view, bottom view, and perspective side view, respectively, of a truck-mounted sparking pad 10c according to the present invention. Each truck-mounted sparking pad 10c includes an elongate base pad 15 fashioned in a wide H shape to define four wrap-around tabs 11 to fit the axle of the skateboard, a plurality of self-adhesive strips 17 on one side of the tabs 11, and a plurality of embedded flint or flint-like contact members 22 evenly spaced along and protruding from the opposing side of the base pad 15. Each T-shaped end of the base pad 15 is scored or perforated along fold lines A and B to facilitate wrapping around and adhering to the respective end of the truck axle as shown in FIG. 12. The middle portion of the base pad 15 adhesively attaches by a self-adhesive strip 17 along the length of the axle. The flint contact members 22 are evenly spaced along and are embedded along the length of the middle section of the base pad 15 to provide multiple points of contact and a true shower of sparks upon contact with a metal rail or curb surface.

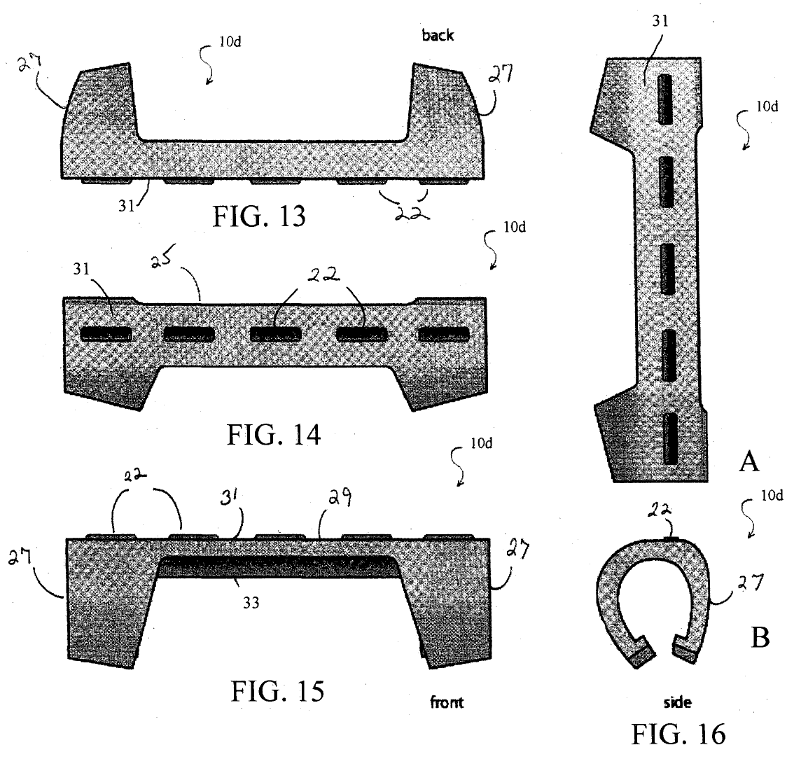

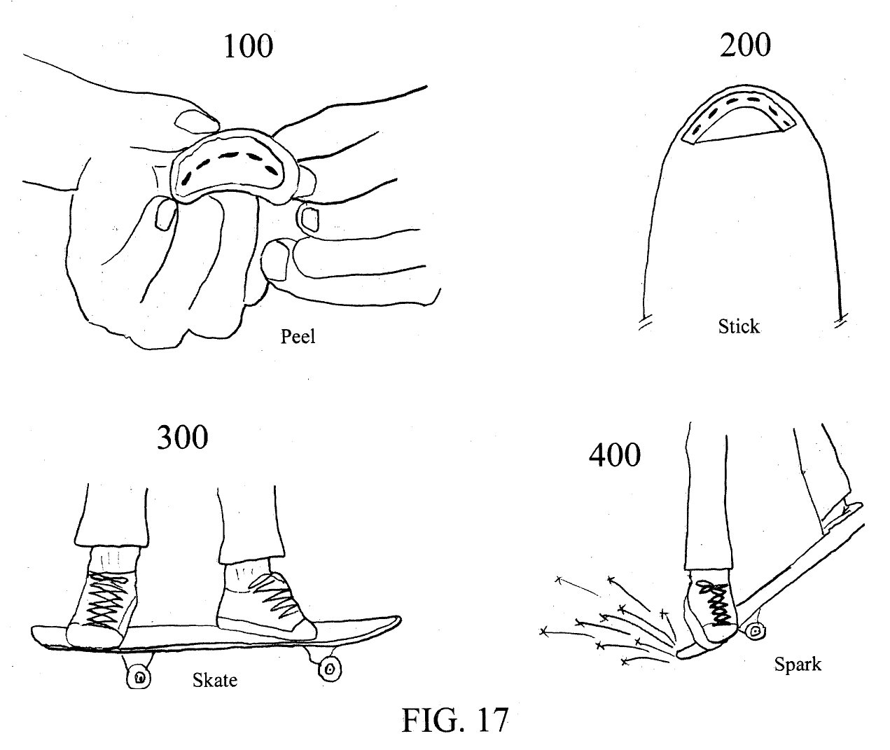

FIGS. 13-16 are a back, bottom, front, and side view of a second embodiment of a truck-mounted sparking pad 10d according to the present invention. Each truck-mounted sparking pad 10d includes an elongate base pad 25 fashioned with a flat outer surface 31, inner surface 33, and two laterally-spaced substantially horseshoe-shaped ends 27 (FIG. 16B) which clip over each end of the axle of the skateboard. Each horseshoe-shaped end 27 can be temporarily moved apart to provide a larger opening in the horseshoe for clipping over the axle. Once fitted over the axle, the sides of each horseshoe-shaped end 27 come together to form a smaller opening. Thus, the truck-mounted sparking pad 27 snaps on to the axle and fits snugly to the bottom of the axle. A plurality of embedded flint or flint-like contact members 22 are evenly spaced along and protruding from the opposing side of the base pad 25. The middle portion 29 of the base pad 25 abuts and curves around the length of the axle. The flint contact members 22 are evenly spaced along and are embedded along the length of the middle section 29 of the base pad 25 to provide multiple points of contact and a true shower of sparks upon contact with a metal rail or curb surface.

FIG. 17 is a composite picture of the four step process of applying and using the sparking pads according to the present invention. At step 100, the skateboarder removes the protective strip from the adhesive side of the plastic sparking pad 10. The skateboarder chooses the particular shape and size and number of the sparking pads 10a-c to conform with the section of the skateboard that he wants to spark. At step 200, the skateboarder attaches the sparking pad 10 to the skateboard by pressing the adhesive side against the skateboard surface. The skateboarder uses the skateboard at step 300. At step 400, the skateboarder, steps down on the tail end of the skateboard, which creates friction between the skateboard sparking pad and the road surface thereby generating sparks from the pad's embedded flint.

It can readily be seen that the skateboard spark generating devices 10a-d according to the present invention can be easily attached to the skateboard, are inexpensive to manufacture, and are safe and easy to use. Moreover, the pads 10a-d may incorporate various colors, shapes, designs, and logos and may be used for promotional purposes.

Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims:

I claim:

1. A sparking pad for attachment to skateboards, comprising:
a base pad having a self-adhesive first side with removable protective sheet, and a raised second side opposite said adhesive first side;
a plurality of flint members embedded in said base pad and protruding from the second side thereof;
whereby the self-adhesive first side attaches to the under surface of a skateboard for use in which friction created by the moving skateboard contacting hard surfaces causes the protruding flint members to generate a shower of sparks.

2. The sparking pad for attachment to skateboards according to claim 1, wherein the base pad comprises any one from among the group of acrylic-polyester, polyester, urethane elastomer, or silicone elastomer.

3. The two-sided sparking pad according to claim 1, wherein the base pad is a straight elongate member adapted to conform to the sides of skateboards.

4. The sparking pad according to claim 1, wherein the base pad is a curved member adapted to conform to the front and back of skateboards.

5. The sparking pad according to claim 1, wherein the base pad is an elongate H-shaped member defining four wrap-around tabs, and a plurality of self-adhesive strips on said tabs, whereby the tabs adhere to a truck axle of the skateboard.

6. The sparking pad according to claim 5, wherein each of said tabs is scored along fold lines to facilitate wrapping around and adhering to the truck axle.

7. The sparking pad according to claim 1, wherein said plurality of flint members are evenly-spaced and laterally-aligned along the second side of said base pad.

8. A sparking pad for attaching to the axles of skateboards, comprising:
an elongate base pad having a raised flat surface on one side, a second side, and two substantially horseshoe-shaped ends turned inwardly toward said second side; and
a plurality of discrete flints embedded along said raised flat surface;
whereby the substantially horseshoe-shaped ends are adapted to clip onto the ends of the axle of the skateboard and the friction created by the moving skateboard coming in contact with a hard surface causes the flint side to generate a shower of sparks.

9. The sparking pad for attaching to the axles of skateboards according to claim 8, wherein the pad is made of any one from among the group comprising acrylic-polyester, polyester, urethane elastomer, or silicone elastomer.

10. The sparking pad according to claim 8, wherein said plurality of flint members are evenly-spaced and laterally-aligned along the raised side of said base pad.

11. A method for generating a shower of sparks from a skateboard that contacts a hard surface, comprising the steps of:
peeling an adhesive protective strip from the self-adhesive side of the sparking pad;
adhering the sparking pad to the bottom surface of a skateboard;
putting the skateboard in motion by riding the skateboard; and
generating a shower of sparks by pushing down on various areas of the skateboard to create contact between the skateboard and a hard surface.

12. A sparking pad for attachment to skateboards, comprising:
an elongate arcuate base pad having a self-adhesive first side with removable protective sheet, and a second side opposite said adhesive first side;
a plurality of flint members embedded in said base pad and protruding from the second side thereof, said flint members being cylindrical segments oriented radially around the arc of said base pad;
whereby the self-adhesive first side attaches to the under surface of a skateboard for use in which friction created by the moving skateboard contacting hard surfaces causes the protruding flint members to generate a shower of sparks.

13. The sparking pad for attachment to skateboards according to claim 12, wherein the base pad comprises any one from among the group of acrylic-polyester, polyester, urethane elastomer, or silicone elastomer.

14. The sparking pad according to claim 12, wherein the arc of said base pad conform to the front and back of skateboards.

15. The sparking pad according to claim 12, wherein said plurality of flint members are evenly-spaced and laterally-aligned along the second side of said base pad.
